(19) United States
(12) Patent Application Publication
(10) Pub. No.: US 2025/0121672 A1
(43) Pub. Date: Apr. 17, 2025

(54) FOUR-WHEEL DRIVE MULTI-GEAR HYBRID POWER TRANSMISSION SYSTEM AND VEHICLE

(71) Applicant: XIAMEN NEVC ADVANCED ELECTRIC POWERTRAIN TECHNOLOGY INNOVATION CENTER, Xiamen (CN)

(72) Inventors: Zhihui DUAN, Xiamen (CN); Jie XING, Xiamen (CN); Maoqiang RAN, Xiamen (CN); Yutao CHEN, Xiamen (CN)

(21) Appl. No.: 18/973,248

(22) Filed: Dec. 9, 2024

(30) Foreign Application Priority Data
Oct. 11, 2023 (CN) 202311317426.5
Oct. 10, 2024 (CN) 202411408326.8

(51) Int. Cl. B60K 6/52; B60K 6/445

(52) U.S. Cl. CPC B60K 6/52; B60K 6/445

(57) ABSTRACT

Provided in the present disclosure is a four-wheel drive multi-gear hybrid power transmission system, including a first drive system and a second drive system that drive two pairs of wheels of a vehicle respectively, where the first drive system includes an engine, a first motor, an input shaft, a first motor shaft, a first output shaft, a first synchronizer, a second synchronizer, and a plurality of gear sets, and the first motor has two gear positions; and the second drive system is an electric drive axle. According to the present disclosure, one motor is reduced, which significantly lowers costs, and multi-gear shifting can be implemented, which improves the fuel consumption economy of the engine and can cope with various working conditions.

### CROSS-REFERENCE TO RELATED APPLICATIONS

This application claims priority to Chinese Patent Application 202411408326.8, filed on Oct. 10, 2024, and Chinese Patent Application 202311317426.5, filed on Oct. 11, 2023, both of which are incorporated herein by reference.

### TECHNICAL FIELD

The present disclosure provides a four-wheel drive multi-gear hybrid power transmission system and a vehicle, and belongs to the technical field of automotive power transmission devices.

### BACKGROUND

Due to the advantages of hybrid vehicles in terms of energy saving and environmental protection, the hybrid vehicles have gradually become a hot development direction in the automotive industry. Compared with conventional fuel-powered four-wheel drive vehicles, four-wheel drive hybrid vehicles have a relatively simple structure. In a four-wheel drive hybrid vehicle, front wheels and rear wheels are driven by two drive systems respectively, with at least one of the drive systems being a hybrid electric system. Thanks to their strong road adaptability, safety, power performance, etc., the four-wheel drive hybrid vehicles have gained widespread popularity among consumers. The capability to achieve multi-mode hybrid drive is one important indicator for the four-wheel drive hybrid vehicles.

There are three technical routes for an existing two-wheel drive hybrid system: a power split system based on planetary gears of dual motors, a parallel system based on a single motor, and a series-parallel system based on dual motors. At present, the main architecture is a P1+P3 dual-motor hybrid architecture (P1 and P3 represent the positions of motors, the motor P1 is located on a crankshaft of an engine, and the motor P3 is located behind a gearbox). The P1+P3 series-parallel hybrid architecture excels in a simple structure, low manufacturing costs, and high transmission efficiency, and has excellent smoothness in a single-gear structure and better fuel economy in a multi-gear structure. Existing four-wheel drive hybrid systems are mostly based on a P1+P3+P4 three-motor hybrid architecture (P1, P3, and P4 represent the positions of motors, the motor P1 is located on a crankshaft of an engine, the motor P3 is located behind a gearbox, and the motor P4 is located on the other axle of a vehicle). Based on the above two-wheel drive hybrid system, a pure electric drive device with a drive motor is added to drive the other axle. The P1+P3+P4 three-motor hybrid architecture includes a power split system with planetary gears of dual motors and a series-parallel system with dual motors. In the technical ideas of the two hybrid architectures, an electric drive system is used as a primary drive source under medium and low loads, and a battery pack is used as a “reservoir” of energy. The operation akin to “peak load shifting” is carried out by a generator and a motor to avoid working conditions where conventional gasoline engines are least efficient, such as low speeds and high loads.

The series-parallel hybrid system with dual motors, such as a four-wheel drive hybrid system, includes an engine, a motor P1, a motor P3, and a motor P4. A front wheel drive system has a short energy transfer path and high mechanical efficiency. The engine can be connected in series and parallel, thereby achieving high flexibility and a wide range of applicable scenes. However, the system lacks a gear shifting mechanism and cannot shift gears. The system needs to be matched with a high-power motor P3 or motor P4 to participate in driving, so as to ensure the power performance of the vehicle. Otherwise, at a relatively high speed, if the driver wants to accelerate again, the power performance will be very poor. Matching the high-power motor P3 significantly increases costs. For another example, the invention patent “Novel Multi-Mode Hybrid Power Transmission System CN201610723146.8” includes an engine, P1+P3 motors, and two rear wheel hub motors. An engine and a motor of a front drive module each has only one gear position, resulting in low efficiency of the engine and the motor. A rear axle in this configuration uses two hub motors, which, although the problem with an arrangement space can be solved, significantly increases costs and technical difficulty.

A hybrid electric vehicle with four-wheel drive can be built in such a way: a power split (PS) system to drive one pair of wheels, and a P4 motor to drive the other pair of wheels. A PS system includes an engine, a generator, and a motor that are coupled together by a planetary gear set. In such a system, three electric motors are indispensable, and the motors are expensive. Due to the decoupling of engine speed, low engine speed can improve the fuel economy and the power performance, but the engine torque is not decoupled from the wheel end, which leads to high difficulty in start-up control. Due to the existence of power cycling in the system, there is low efficiency at a high vehicle speed, the generator performs discharging inefficiently, and the motor performs charging inefficiently.

In summary, no matter whether the four-wheel drive hybrid system is the series-parallel system with dual motors or the power split system, one motor P4 must be added to achieve four-wheel drive, thereby significantly increasing costs. The motors P1 and P3 have their own roles in power generation and direct drive, and are indispensable.

There is a P1+P4 four-wheel drive structure, such as the invention patent “Hybrid Drive Assembly and Automobile CN202310896432.4”, including a motor P1, an engine, a plurality of synchronizers, and a gear set that serve as a front drive unit, and a rear drive unit where a single motor and a mechanical structure are connected to wheels. The engine and the motor P1 in this configuration each has three gear positions. Compared with a commonly used one-gear structure, the better power performance and economy can be achieved, and one motor P3 can be omitted to significantly reduce costs. However, the engine and the motor P1 are fixedly connected and cannot be decoupled, so that four-wheel drive cannot be implemented in a pure electric state, thereby narrowing the application range. Moreover, there are defects of many parts, a complex structure, high costs, large occupied space, and difficulty in arrangement.

### SUMMARY

In view of the technical problems to be solved, the present disclosure provides a four-wheel drive four-gear hybrid power transmission system, including a front wheel drive system and a rear wheel drive system. An engine drives front wheels and has four gear positions, which can improve the fuel economy of the engine. The front wheel drive system only has a motor. The motor has two gear positions, which well balance a large thrust and a high rotational speed. The rear wheel drive system is an electric drive axle, including a rear axle motor and a reduction gear. Most series-parallel hybrid four-wheel drive configurations require the use of three motors (P1+P3+P4), and power-split four-wheel drive hybrid systems also need three motors. However, this system only requires two motors, so that one motor is reduced, the costs are significantly lowered, and the system is simple and compact in structure and has low requirements on an arrangement space. In an EV or HEV mode, the system can provide four-wheel drive, and gear shifting without power interruption can be implemented, thereby improving the safety of vehicle driving, the passability on complex road surfaces, the off-road capability, and the drive capability on wet and slippery road surfaces. Moreover, multi-gear shifting can be implemented, thereby improving the fuel consumption economy of the engine. The system is a full-time four-wheel drive hybrid power transmission system with multiple electric vehicle and hybrid electric vehicle modes, which can cope with various working conditions.

A four-wheel drive multi-gear hybrid power transmission system includes a front wheel drive system and a rear wheel drive system.

The front wheel drive system includes an engine, a front axle motor, a first motor shaft, an input shaft, a first output shaft, two pairs of synchronizers, and a plurality of gear sets. The input shaft is connected to the engine. The input shaft is sleeved with a left gear and a right gear. A pair of synchronizers is connected to the input shaft. The input shaft is connected or not connected to the left gear and the right gear separately by the synchronizers. When engaging the left gear, the synchronizer is connected to the left gear. When engaging the right gear, the synchronizer is connected to the right gear. When placed in a middle, the synchronizer is not connected to the left gear and the right gear. The first output shaft is sleeved with a left gear and a right gear, a pair of synchronizers are connected to the first output shaft, and the first output shaft is connected or not connected to the left gear and the right gear separately by the synchronizers. The first motor shaft is connected to the first axle motor. The first motor shaft is provided with a left gear and a right gear that are in meshing transmission with the gears on the input shaft and the first output shaft.

The rear wheel drive system includes a rear axle motor, a second motor shaft, and a rear output shaft. The rear axle motor and the rear output shaft are connected to a final drive directly or by a speed reduction mechanism.

The front wheel drive system is coupled to the rear wheel drive system by the ground. The front axle motor is electrically connected to the rear axle motor.

The gears on the two motor shafts are simultaneously meshed with the gears on the input shaft and the gears on the output shaft. The gears on the input shaft and the gears on the output shaft are not meshed with each other. The gears on each of the two motor shafts include two gears connected as a whole. One of the gears is meshed with the gear on the input shaft, and the other gear is meshed with the gear on the output shaft. This facilitates the design of a suitable speed ratio.

Alternatively, the gears on the output shaft are simultaneously meshed with the gears on the motor shaft and the gears on the input shaft. The gears on the motor shaft and the gears on the input shaft are not meshed with each other. The gears on the output shaft include two gears connected as a whole. One of the gears is meshed with the gear on the input shaft, and the other gear is meshed with the gear on the motor shaft. This facilitates the design of a suitable speed ratio.

Alternatively, the gears on the input shaft are simultaneously meshed with the gears on the motor shaft and the gears on the output shaft. The gears on the motor shaft and the gears on the output shaft are not meshed with each other. The gears on the input shaft include two gears connected as a whole. One of the gears is meshed with the gear on the output shaft, and the other gear is meshed with the gear on the motor shaft. This facilitates the design of a suitable speed ratio.

The two synchronizers may be both replaced with clutches.

This variable-speed transmission system has any one or more of the following working modes. The front axle motor can only drive the front output shaft. The rear axle motor can only drive the rear output shaft. The “front output shaft” and the “rear output shaft” described below are both referred to as “output shaft”.

In an electric vehicle mode, the front axle motor or the rear axle motor participates in driving the output shaft and can implement power gear-shifting.

In a series mode, the engine drives the front axle motor to generate power, and the rear axle motor drives the output shaft.

In a parallel mode, the engine drives the output shaft by selecting a gear position, and the front axle motor and the rear axle motor can drive, generate power, or idle separately and can implement power gear-shifting.

The present disclosure further provides a hybrid vehicle, including the four-wheel drive multi-gear hybrid power transmission system.

The present disclosure has the following beneficial effects:

This design is a full-time four-wheel drive hybrid power system with an engine with four gear positions.

Compared with a simple series-parallel hybrid power system (a first gear, a second gear, and a third gear in the prior art), this design can realize that the engine has four gear positions, which can improve the fuel economy of the engine and enhance the acceleration performance of the complete vehicle. Compared with a simple single-gear motor, the front wheel drive motor in the present disclosure has two gear positions, which well balance a large thrust and a high rotational speed, thereby further reducing costs. The second motor of the rear wheel drive system can be provided with the speed reduction mechanism with the moderate speed ratio, and has good thrust and efficiency at a medium speed.

Compared with other four-gear four-wheel drive hybrid power systems, this design has the following advantages: a speed change mechanism is a parallel shaft gear, thereby reducing costs; all gear shifting mechanisms are synchronizers with high efficiency, low cost, and simple control mechanisms, which helps to improve the fuel economy of the vehicle and reduce manufacturing costs; only two pairs of synchronizers are needed, so that compared with a clutch system, a complex hydraulic mechanism is omitted, and the number of gear shifting execution mechanisms is reduced, thereby reducing costs; this design is superior to dual-power alternating drive and gear shifting, and the requirements for gear shifting transition time and the requirements for the gear shifting execution mechanisms are reduced, thereby reducing costs; and only the synchronizers are used as the gear shifting mechanisms, and there are few types of gear shifting mechanisms, thereby reducing costs.

Compared with the above P1+P3+P4 four-wheel drive hybrid power system, only two motors are provided in this design, so that one motor is reduced, thereby significantly reducing costs. The two motors can drive a front axle and a rear axle respectively, thereby maximizing the efficiency. The front axle motor can be decoupled from the engine, thereby having two functions of drive and power generation (TM/GM). The system can implement the four-wheel drive function without increasing costs, brings the experience of four-wheel drive, the price of two-wheel drive, the performance of four-wheel drive, and the energy consumption of two-wheel drive, and has the advantages of good power performance, low fuel consumption, reduced arrangement space for the complete vehicle, and significant cost reduction. The front wheel drive system has a compact structure and a small axial dimension, thereby being conducive to promotion and application. The rear wheel drive system only uses one motor, thereby reducing costs.

In the above P1+P4 four-wheel drive hybrid power system, multiple pairs of parallel shaft gears, a planetary gear row, a clutch, and a synchronizer are used, and the mechanical structure is complex. The use of the planetary gear row increases manufacturing difficulty and costs. This system uses a single gear shifting execution mechanism (only uses a synchronizer). Compared with a system using both a clutch and a synchronizer, the control difficulty is lowered, a complex hydraulic gear shifting execution mechanism is omitted, and the costs are reduced. This system uses fewer parts to achieve four gear positions, and has a simple structure. The front axle motor of this system can be decoupled from the engine, and can implement four-wheel drive in the electric vehicle mode, thereby improving the adaptability to road conditions. When the rear axle motor P4 of this system fails, only the front axle motor can also drive the wheels to provide power, thereby improving the capability to cope with harsh working conditions.

According to the four-gear hybrid power transmission system in the present disclosure, during gear shifting of the engine, the front axle motor drives the engine to adjust the speed, and when the front axle motor drives the engine to adjust the speed, the rear axle motor can provide power to drive the rear axle wheels to compensate for power, thereby implementing gear shifting without power interruption smoothly and comfortably, and ensuring the smoothness of vehicle driving; in the electric vehicle (EV) mode, gear shifting without power interruption can be implemented by the cooperation between the front axle motor and the rear axle motor smoothly and comfortably; and the rear wheel drive system can cooperate with the front wheel drive system to enable the vehicle to have a full-time four-wheel drive function so as to better adapt to road conditions.

The front axle motor, the rear axle motor, and the wheels connected thereto have a simple mechanical structure, a short transmission path, and high braking energy recovery efficiency.

### BRIEF DESCRIPTION OF DRAWINGS

FIG. 1 is a schematic diagram of Embodiment 1 in the present disclosure;

FIG. 2 is a schematic diagram of Embodiment 2 in the present disclosure; and

FIG. 3 is a schematic diagram of Embodiment 3 in the present disclosure.

### DESCRIPTION OF EMBODIMENTS

The present disclosure is further described below with reference to the accompanying drawings.

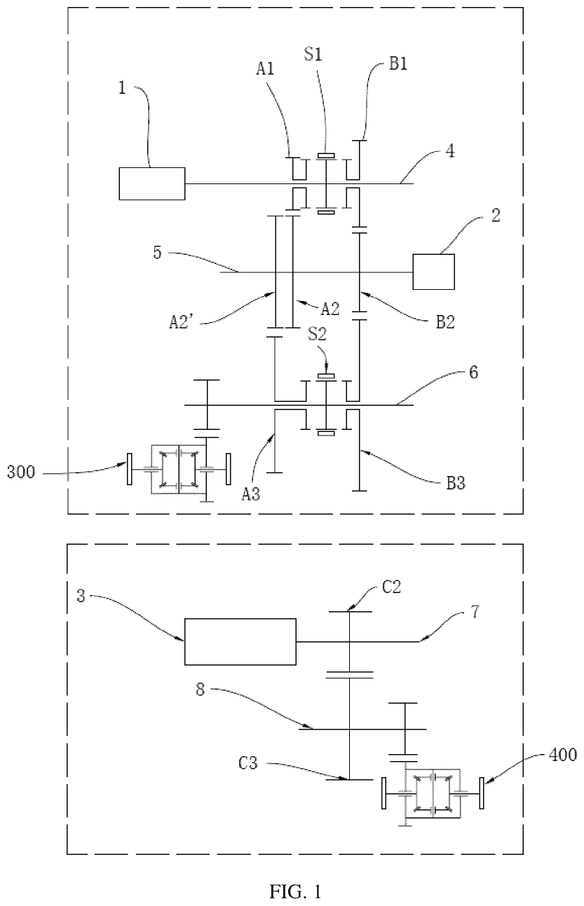

Referring to FIG. 1 to FIG. 3, a four-wheel drive multi-gear hybrid power transmission system includes a first drive system and a second drive system, where
the first drive system includes an engine, a first motor, an input shaft, a first motor shaft, a first output shaft, a first synchronizer, a second synchronizer, and a plurality of gear sets, the input shaft is connected to the engine, the first motor shaft is connected to the first motor, the first synchronizer is connected to the input shaft, the second synchronizer is connected to the output shaft, the input shaft, the first motor shaft, and the output shaft are provided with the matched gear sets to implement transmission connection, the input shaft implements gear shifting with at least two gears on the input shaft by the first synchronizer, the output shaft implements gear shifting with at least two gears on the output shaft by the second synchronizer, and the first drive system outputs a torque by the first output shaft to provide front wheel drive power or rear wheel drive power; and
the second drive system includes a second motor and a second output shaft, the second motor and the second output shaft are connected directly or by a speed reduction transmission mechanism, and the second drive system outputs a torque by the second output shaft to provide rear wheel drive power or front wheel drive power.

The first drive system may be a front wheel drive system or a rear wheel drive system. When the first drive system is used as the front wheel drive system, the second drive system is the rear wheel drive system. When the first drive system is used as the rear wheel drive system, the second drive system is the front wheel drive system. In the following embodiments, the first drive system serves as the front wheel drive system, and the second drive system serves as the rear wheel drive system. Specifically, the first motor is also referred to as a front axle motor, the first output shaft is referred to as a front output shaft, the second motor is also referred to as a rear axle motor, the second output shaft is referred to as a rear output shaft, and others are similar.

### Embodiment 1

As shown in FIG. 1, a four-wheel drive multi-gear hybrid power transmission system includes a front wheel drive system and a rear wheel drive system. At this time, the first drive system 100 is defined as the front wheel drive system, and the second drive system 200 is defined as the rear wheel drive system.

The front wheel drive system includes an engine 1, a first motor 2, an input shaft 4, a first motor shaft 5 (i.e., a transmission shaft), a first output shaft 6 (i.e., a front output shaft), a first synchronizer S1, and a second synchronizer S2. The input shaft 4 is connected to the engine 1. The input shaft 4 is sleeved with a first gear A1 and a second gear B1. The first synchronizer S1 is connected to the input shaft 4. The input shaft 4 is connected or not connected to the first gear A1 or the second gear B1 separately by the first synchronizer S1. Specifically, as shown in FIG. 1, when the first synchronizer S1 moves left to be engaged with the first gear A1, the input shaft 4 is connected to the first gear A1. When the first synchronizer S1 moves right to be engaged with the second gear B1, the input shaft 4 is connected to the second gear B1. When the first synchronizer S1 is in a neutral position, the input shaft 4 is not connected to both the first gear A1 and the second gear B1. The first output shaft 6 is sleeved with a third gear A3 and a fourth gear B3. The second synchronizer S2 is connected to the first output shaft 6. The first output shaft 6 is connected or not connected to the third gear A3 or the fourth gear B3 separately by the second synchronizer S2. Specifically, as shown in FIG. 1, when the second synchronizer S2 moves left to be engaged with the third gear A3, the first output shaft 6 is connected to the third gear A3. When the second synchronizer S2 moves right to be engaged with the fourth gear B3, the first output shaft 6 is connected to the fourth gear B3. When the second synchronizer S2 is in a neutral position, the first output shaft 6 is not connected to both the third gear A3 and the fourth gear B3.

The first motor shaft 5 is connected to a shaft of the first motor 2. The first motor shaft 5 is connected to a fifth gear A2, a seventh gear A2′, and a sixth gear B2. The fifth gear A2 and the seventh gear A2′ are connected side by side. The fifth gear A2 is meshed with the first gear A1. The seventh gear A2′ is meshed with the third gear A3. The first gear A1 and the third gear A3 are not meshed with each other. The sixth gear B2 is meshed with both the second gear B1 and the fourth gear B3. The second gear B1 and the fourth gear B3 are not meshed with each other.

The rear wheel drive system includes a second motor 3, a second motor shaft 7, and a second output shaft 8 (i.e., a rear output shaft). The second motor shaft 7 transmits power to wheels by a speed reduction mechanism and a final drive or other speed reduction transmission mechanisms. The speed reduction mechanism includes an eighth gear C2 and a ninth gear C3.

System function table 1

| | | First | Second | | |
|---|---|---|---|---|---|
| | Engine 1 | motor 2 | motor 3 | S1 | S2 |
| EV medium and | Off | Drive | Drive | | Right |
| low-speed drive | | | | | |
| EV on-load gear | Off | Synchron- | Drive | | Right <=> |
| shifting | | ization | | | left |
| | | adjustment | | | |
| EV medium and | Off | Drive | Drive | | Left |
| high-speed drive | | | | | |
| EV <=> four- | Off => | Drive of | Drive | Left | |
| wheel drive | start | engine 1 | | (or | |
| series HEV | | | | right) | |
| Series HEV | Drive | Power | Drive | Left | |
| | | generation | | (or | |
| | | | | right) | |
| Series <=> first | Following | Synchron- | Drive | Left | off <=> |
| gear | | ization | | | right |
| | | adjustment | | | |
| HEV medium and | Drive | Drive | Drive | Left | Right/left |
| low-speed drive | | | | | |
| HEV on-load | Following | Synchron- | Drive | Left | Left <=> |
| gear shifting | | ization | | <=> | right |
| | | adjustment | | right | |
| HEV medium and | Drive | Drive | Drive | Right | Right/ |
| high-speed drive | | | | | left |
| Energy | Idling or | Braking/ | Supple- | | |
| regenerative | stalling | power | mentation | | |
| braking | | generation | | | |
| Vehicle towing | Off | Gear | Off | | |
| | | disengage- | | | |
| | | ment/off | | | |

Note:
D/G represents that the motor is connected to a transmission chain and follows, and can be switched to a drive or power generation state at any time as needed.

When the system works in various modes, the components are set as follows.

In a two-wheel drive EV mode, when the engine 1 is off, the first synchronizer S1 and the second synchronizer S2 disengage the gears, and the second motor 3 outputs power by the eighth gear C2 on the second motor shaft 7, the ninth gear C3 on the second output shaft 8, and the final drive. The speed reduction mechanism (C3/C2) has a medium speed ratio. A medium speed ratio of the second motor is between two speed ratios of the first motor.

In a four-wheel drive EV mode, when the engine 1 is off, the first synchronizer S1 disengages the gear to cut off the connection with the transmission chain; the second synchronizer S2 engages the fourth gear B3 (or the third gear A3), the first motor 2 drives the first output shaft 6 and front wheels 300 by the gear pair B2/B3 (or the gear pair A2′/A3), and the second drive system 200 drives rear wheels 400, thereby implementing four-wheel drive of an EV; and the first motor 2 has two gear positions: a high speed ratio B2/B3 and a low speed ratio A2′/A3 as in this embodiment.

In a series HEV mode, when the engine 1 is on, the first synchronizer S1 is engaged to one gear position, the engine 1 is connected to the first motor 2; the second synchronizer S2 is separated, and the engine 1 is separated from the first output shaft 6; and the engine 1 drives the first motor 2 to generate power and supplies the power to the second drive system 200, and the second drive system 200 drives a corresponding pair of wheels.

In a four-wheel drive parallel HEV mode, when the engine 1 is on, the first synchronizer S1 engages one gear position and the second synchronizer S2 engages one gear position, the engine 1 and the first motor 2 drive one pair of wheels by transmission gears and the first output shaft 6, and the second drive system 200 drives the other pair of wheels. The two synchronizers each has two gear engagements and together form four combinations to constitute four gear positions of the engine 1. Specifically, when the first synchronizer S1 moves left and the second synchronizer S2 moves left (left-left gear engagement), the engine 1 drives the first output shaft 6 by the first gear A1, the fifth gear A2, the seventh gear A2′, and the third gear A3, which is a first gear position; when the first synchronizer S1 moves left and the second synchronizer S2 moves right (left-right gear engagement), the engine 1 drives the first output shaft 6 by the first gear A1, the fifth gear A2, the sixth gear B2, and the fourth gear B3, which is a second gear position; when the first synchronizer S1 moves right and the second synchronizer S2 moves left (right-left gear engagement), the engine 1 drives the first output shaft 6 by the second gear B1, the sixth gear B2, the seventh gear A2′, and the third gear A3, which is a third gear position; and when the first synchronizer S1 moves right and the second synchronizer S2 moves right (right-right gear engagement), the engine 1 drives the first output shaft 6 by the second gear B1, the sixth gear B2, and the fourth gear B3, which is a fourth gear position.

Gear shifting without power interruption is performed in the four-wheel drive EV mode.

In the four-wheel drive EV mode, the first motor 2 can be shifted from the gear position with the speed ratio B2/B3 to the gear position with the speed ratio A2′/A3, where the first motor 2 is uploaded to the second motor 3, and the second motor 3 continues to drive; after the first motor 2 is unloaded, the second synchronizer S2 disengages a right gear; the first motor 2 adjusts speed for synchronization, and after the third gear A3 is synchronized with the first output shaft 6, the second synchronizer S2 engages a left gear; and torque distribution is adjusted to complete gear shifting.

Similarly, the first motor 2 can be shifted from the gear position with the low speed ratio A2′/A3 to the gear position with the high speed ratio B2/B3, where the first motor 2 transfers the load to the second motor 3, and the second motor 3 continues to drive; after the first motor 2 is unloaded, the second synchronizer S2 disengages the left gear; the first motor 2 performs synchronization adjustment, and after the fourth gear B3 is synchronized with the first output shaft 6, the second synchronizer S2 engages the right gear; and torque distribution is adjusted to complete gear shifting.

From this, it can be seen that in the EV mode, when the first motor 2 performs gear shifting, there is always the second motor 3 driving and compensating for a torque of the first motor 2, so there is no power interruption during gear shifting.

The four-wheel drive EV mode is switched to the series HEV mode.

The vehicle can smoothly switch from the four-wheel drive EV mode to the series drive HEV mode.

Before switching, in the four-wheel drive EV mode, when the engine 1 is off, the first synchronizer S1 disengages the gear, the second synchronizer S2 engages, the first motor 2 drives the first output shaft 6 by the second synchronizer S2 and the corresponding gears, and the second motor 3 drives the second output shaft 8 by the eighth gear C2 and the ninth gear C3.

The switching process is as follows: firstly, the load of the first motor 2 is uploaded to the second motor 3, and the second motor 3 continues to drive; then, the second synchronizer S2 disengages the gear; next, after the motor performs synchronization adjustment, the first synchronizer S1 engages the left gear; the first motor 2 drives and starts the engine 1 by the gear pair A2/A1, the first synchronizer S1, and the input shaft 4; and then, the engine 1 enters a working state, outputs power, drives the first motor 2 to generate electric power, supplies the power for the second motor 3 to drive the vehicle, and the system enters the series drive HEV mode.

The engine 1 of this system has four gear positions. The series drive mode is only used when the vehicle speed is very low (within ten kilometers per hour). When the vehicle speed is a little high, the system will engage a gear and enter the parallel drive mode. Accordingly, the drive time of the second motor 3 is very short.

The series HEV mode is switched to the four-wheel drive parallel HEV mode.

When the vehicle speed is very low (within ten kilometers per hour), the system is in the series drive HEV mode. As the vehicle speed increases, the system enters the four-wheel drive parallel HEV mode. The engine 1 has four gear positions, that is, the engine 1 can directly drive the vehicle at four different speed ratios. The working efficiency of the engine 1 is higher than that of a series-parallel hybrid power transmission system with three gears or less. The first motor 2 has two gear positions, which can achieve a good balance between the acceleration performance and the fuel economy. Meanwhile, the torque and speed requirements are reduced, which is beneficial for reducing costs, weight, and NVH. The second motor 3 has a gear position with a medium speed ratio, and the torque and speed requirements of the second motor 3 are moderate.

The series HEV mode can be smoothly switched to a first gear in the four-wheel drive parallel HEV mode. In the series HEV mode, when the first synchronizer S1 engages the left gear, the first motor shaft 5 is connected to the input shaft 4, and the engine 1 drives the first motor 2 to generate power; and the second motor 3 of a rear axle drives the second output shaft 8 by the eighth gear C2 and the ninth gear C3. The series drive mode is switched to the parallel drive mode by the following steps: the second motor 3 of the rear axle continues to drive, so that the vehicle has no power interruption; the first motor 2 of a front axle drives the engine 1 to adjust the speed, so that when the fourth gear B3 is synchronized with the first output shaft 6, the second synchronizer S2 engages the right gear; then the torque is adjusted and distributed to enter a first-gear parallel drive mode; and the engine 1 drives the first output shaft 6 by the input shaft 4, the first gear A1, the fifth gear A2, the seventh gear A2′, the third gear A3, the sixth gear B2, and the fourth gear B3, thereby driving the front wheels 300. The second motor 3 of the rear axle drives the second output shaft 8 by the second motor shaft 7, the eighth gear C2, and the ninth gear C3 to output power.

Similarly, the system can switch from the series drive HEV mode to other gear positions in the four-wheel drive parallel HEV mode.

Gear shifting without power interruption is performed in the HEV mode.

The system can implement gear shifting without power interruption. During gear shifting, the engine 1 is unloaded (the output torque is reduced to zero); the second motor 3 compensates for unloading of the engine 1 and maintains drive by the eighth gear C2 and the ninth gear C3; after the original gear position synchronizer disengages the gear, the first motor 2 drives the engine 1 to perform synchronization adjustment; and when the new gear is synchronized with the relevant shaft, the synchronizer engages the gear; and then the torque is adjusted and distributed to complete gear shifting.

A first gear of an HEV can be smoothly switched to a second gear of the HEV: when the engine 1 is unloaded, the second motor 3 increases the torque for compensation; the second motor 3 continues to drive by the eighth gear C2 and the ninth gear C3, so that there is no power interruption in the vehicle; after the torque of the engine 1 is reduced to zero, the right gear of the second synchronizer S2 can be easily disengaged; then, the first motor 2 drives the engine 1 to adjust the speed, so that the third gear A3 is synchronized with the first output shaft 6; and then the second synchronizer S2 engages the left gear, the engine 1 drives the first output shaft 6 by the input shaft 4, the first gear A1, the fifth gear A2, the seventh gear A2′, and the third gear A3, and the engine 1 engages the second gear of the HEV. After the engine 1 engages the second gear of the HEV, the second motor 3 can choose to work or not, and can be switched to the drive or power generation state at any time as needed. All gear changes without the first synchronizer S1 switching can be smoothly done in some similar ways.

The second gear of the HEV can be smoothly switched to a third gear of the HEV: when the engine 1 is unloaded, the second motor 3 increases the torque for compensation; the second motor 3 continues to drive by the eighth gear C2 and the ninth gear C3, so that there is no power interruption in the vehicle; after the torque of the engine is reduced to zero, the gear position of the second synchronizer S2 can be easily disengaged; then, the first motor 2 drives the engine 1 to adjust the speed, so that the first gear A1 is synchronized with the input shaft 4, and then the first synchronizer S1 engages the right gear; and then the first motor 2 drives the engine 1 to adjust the speed, so that the fourth gear B3 is synchronized with the first output shaft 6, then the second synchronizer S2 engages the right gear, the engine drives the first output shaft 6 by the input shaft 4, the second gear B1, the sixth gear B2, and the fourth gear B3, and the engine 1 engages the third gear of the HEV After the engine engages the third gear of the HEV, the second motor 3 can choose to work or not, and can be switched to the drive or power generation state at any time as needed. All gear changes with the first synchronizer S1 switching can be smoothly done in some similar ways.

The third gear of the HEV can be smoothly switched to a fourth gear of the HEV: when the engine 1 is unloaded, the second motor 3 increases the torque for compensation; the second motor 3 continues to drive by the eighth gear C2 and the ninth gear C3, so that there is no power interruption in the vehicle; after the torque of the engine is reduced to zero, the right gear of the second synchronizer S2 can be easily disengaged; then, the first motor 2 drives the engine 1 to adjust the speed, so that the third gear A3 is synchronized with the first output shaft 6, and then the second synchronizer S2 engages the left gear; and the engine 1 drives the first output shaft 6 by the input shaft 4, the second gear B1, the sixth gear B2, the seventh gear A2′, and the third gear A3, and the engine 1 engages the fourth gear of the HEV After the engine engages the fourth gear of the HEV, the second motor 3 can choose to work or not, and can be switched to the drive or power generation state at any time as needed.

The present disclosure further provides a hybrid vehicle, including the above four-wheel drive multi-gear hybrid power transmission system. As one motor is reduced, the costs are significantly lowered; gear shifting without power interruption can be implemented in the EV or HEV mode; and multi-gear shifting can be implemented, which improves the fuel consumption economy of the engine and can cope with various working conditions.

### Embodiment 2

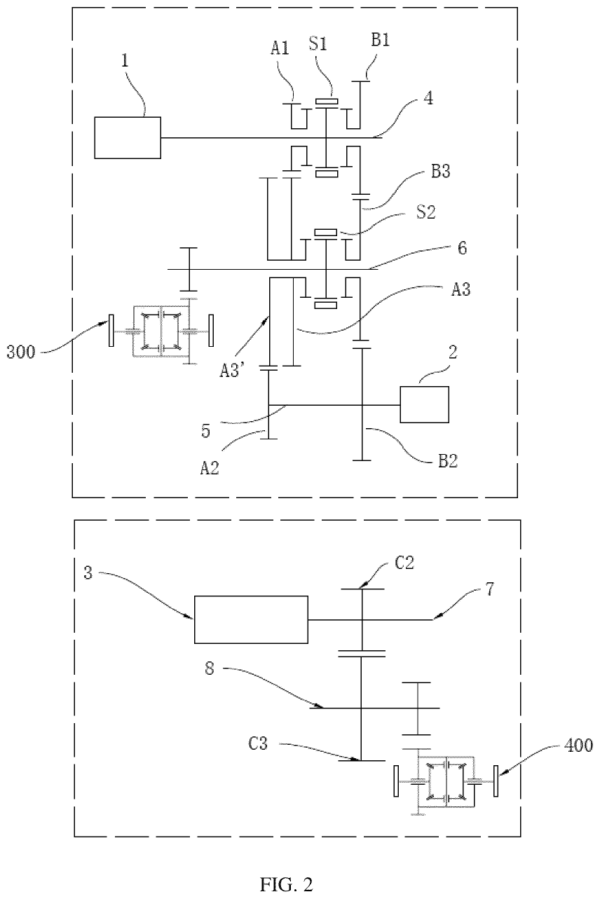

As shown in FIG. 2, a hybrid power system in the present disclosure includes a front wheel drive system and a rear wheel drive system.

The front wheel drive system includes an engine 1, a first motor 2, a parallel shaft gear set, and two pairs of synchronizers required for gear shifting. The engine 1 has four gear positions, and the first motor 2 has two gear positions. The two pairs of synchronizers implement gear position switching, thereby achieving a single type of gear shifting mechanism, a simple actuation mechanism, and low costs. A speed change mechanism composed of the parallel shaft gears and the synchronizers has mature technology, low manufacturing costs, high transmission efficiency, and low energy loss.

The engine 1 is connected to the input shaft 4. The input shaft 4 is provided with a first synchronizer S1, a first gear A1, and a second gear B1. If the first synchronizer S1 engages a left gear, then the input shaft 4 is connected to the first gear A1. If the first synchronizer S1 engages a right gear, then the input shaft 4 is connected to the second gear B1.

The first output shaft 6 is provided with a third gear A3, a tenth gear A3′, a fourth gear B3, and a second synchronizer S2. The third gear A3 and the tenth gear A3′ are connected side by side. When the second synchronizer S2 engages the left gear, the first output shaft 6 is connected to the third gear A3 and the tenth gear A3′. When the second synchronizer S2 engages the right gear, the first output shaft 6 is connected to the fourth gear B3, the third gear A3 is meshed with the first gear A1, and the fourth gear B3 is meshed with the second gear B1.

The first motor 2 is connected to the first motor shaft 5. The first motor shaft 5 is provided with a fifth gear A2 and a sixth gear B2. The fifth gear A2 is meshed with the tenth gear A3′. The sixth gear B2 is meshed with the fourth gear B3.

The rear wheel drive system includes a second motor 3, a second motor shaft 7, and a second output shaft 8. The second motor shaft 7 transmits power to wheels by a speed reduction mechanism and a final drive or other speed reduction transmission mechanisms. The speed reduction mechanism includes an eighth gear C2 and a ninth gear C3.

Similar to the above fifth gear A2 and seventh gear A2′, the third gear A3 and the tenth gear A3′ are two gears connected side by side. The third gear A3 is meshed with the first gear A1, and the tenth gear A3′ is meshed with the fifth gear A2, thereby making the speed ratio design of each gear position more flexible.

System function table 2

| | | First | Second | | |
|---|---|---|---|---|---|
| | Engine 1 | motor 2 | motor 3 | S1 | S2 |
| EV medium and | Off | Drive | Drive | | Left |
| low-speed drive | | | | | |
| EV on-load gear | Off | Synchron- | Drive | | Left <=> |
| shifting | | ization | | | right |
| | | adjustment | | | |
| EV medium and | Off | Drive | Drive | | Right |
| high-speed drive | | | | | |
| EV <=> four- | Off => | Drive of | Drive | Left | |
| wheel drive series | start | engine 1 | | (or | |
| HEV | | | | right) | |
| Series HEV | Drive | Power | Drive | Left | |
| | | generation | | (or | |
| | | | | right) | |
| Series <=> first | Following | Synchron- | Drive | Left | off <=> |
| gear | | ization | | | right |
| | | adjustment | | | |
| HEV medium and | Drive | Drive | Drive | Left/ | Left |
| low-speed drive | | | | right | |
| HEV on-load gear | Following | Synchron- | Drive | Left | Left <=> |
| shifting | | ization | | <=> | right |
| | | adjustment | | right | |
| HEV medium and | Drive | Drive | Drive | Left/ | Right |
| high-speed drive | | | | right | |
| Energy | Idling or | Braking/ | Supple- | Left/ | Left/ |
| regenerative | stalling | power | mentation | right | right |
| braking | | generation | | | |
| Vehicle towing | Off | Gear | Off | | |
| | | disengage- | | | |
| | | ment/off | | | |

Note:
D/G represents that the motor is connected to a transmission chain and follows, and can be switched to a drive or power generation state at any time as needed.

When the system works in various modes, the components are set as follows.

EV modes are as follows.

In a two-wheel drive EV mode, when the engine 1 is off, the first synchronizer S1 and the second synchronizer S2 disengage the gears, and the second motor 3 outputs power by the eighth gear C2 on the second motor shaft 7, the ninth gear C3 on the second output shaft 8, and the final drive.

In a four-wheel drive EV mode, when the engine 1 is off, the first synchronizer S1 disengages the gear to cut off the connection with the transmission chain; the second synchronizer S2 engages the fourth gear B3 (or the third gear A3), the first motor 2 drives the first output shaft 6 and front wheels 300 by the gear pair B2/B3 (or the gear pair A2′/A3), and the second drive system 200 drives rear wheels 400, thereby implementing four-wheel drive of an EV; and the first motor 2 has two gear positions: a high speed ratio A2/A3′ and a low speed ratio B2/B3 as in this embodiment.

In a series HEV mode, when the engine 1 is on, the first synchronizer S1 engages one gear position, the engine 1 is connected to the first motor; the second synchronizer S2 is separated, and the engine 1 is separated from the first output shaft 6; and the engine 1 drives the first motor 2 to generate power and supplies the power to the second drive system 200, and the second drive system 200 drives corresponding rear wheels 400.

In a four-wheel drive parallel HEV mode, when the engine 1 is on, the first synchronizer S1 engages one gear position and the second synchronizer S2 engages one gear position, the engine 1 and the first motor 2 drive one pair of wheels by transmission gears and the first output shaft 6, and the second drive system drives the other pair of wheels. The two synchronizers have four combinations of gear engagement states to constitute four gear positions of the engine 1. Specifically, when the first synchronizer S1 moves left and the second synchronizer S2 moves left, the engine drives the first output shaft 6 by the gear set A1 and A2, which is a first gear position; when the first synchronizer S1 moves left and the second synchronizer S2 moves right, the engine 1 drives the first output shaft 6 by the gear set A1, A3, A3′, A2, B2, and B3, which is a second gear position; when the first synchronizer S1 moves right and the second synchronizer S2 moves left, the engine 1 drives the first output shaft 6 by the gear set B1, B3, B2, A2, and A3′, which is a third gear position; and when the first synchronizer S1 moves right and the second synchronizer S2 moves right, the engine 1 drives the first output shaft 6 by the gear set B1 and B2, which is a fourth gear position.

In a rear-wheel drive EV mode, when the engine 1 is off, the first synchronizer S1 and the second synchronizer S2 disengage the gears; and the second motor 3 outputs power by the eighth gear C2 on the second motor shaft 7, the ninth gear C3 on the second output shaft 8, and the final drive. The speed reduction mechanism (C3/C2) has a medium speed ratio.

In a four-wheel drive EV mode, the first motor 2 and the second motor 3 can together drive and output power to four wheels, and the first motor 2 can have a high reduction ratio (a torque increase ratio), so the two motors have low torque requirements; and due to a medium speed ratio of the second motor 3 and two speed ratios of the first motor 2, the two motors have moderate speed requirements.

Gear shifting without power interruption is performed in the four-wheel drive EV mode.

In the four-wheel drive EV mode, the first motor 2 can be shifted from the gear position with the speed ratio A2/A3′ to the gear position with the speed ratio B2/B3, where the first motor 2 is unloaded to the second motor 3, and the second motor 3 continues to drive; after the first motor 2 is unloaded, the second synchronizer S2 disengages the left gear; the first motor 2 adjusts speed for synchronization, and after the fourth gear B3 is synchronized with the first output shaft 6, the second synchronizer S2 engages the right gear; and torque distribution is adjusted to complete gear shifting.

Similarly, the first motor 2 can be shifted from the gear position with the low speed ratio B2/B3 to the gear position with the high speed ratio A2/A3′, where the first motor 2 transfers the load to the second motor 3, and the second motor 3 continues to drive; after the first motor 2 is unloaded, the second synchronizer S2 disengages the right gear; the first motor 2 performs synchronization adjustment, and after the tenth gear A3′ is synchronized with the first output shaft 6, the second synchronizer S2 engages the left gear; and torque distribution is adjusted to complete gear shifting.

From this, it can be seen that in the EV mode, when the first motor 2 performs gear shifting, there is always the second motor 3 driving and compensating for a torque of the first motor 2, so there is no power interruption during gear shifting.

The four-wheel drive EV mode is switched to the series HEV mode.

The vehicle can smoothly switch from the four-wheel drive EV mode to the series drive HEV mode.

Before switching, in the four-wheel drive EV mode, when the engine 1 is off, the first synchronizer S1 disengages the gear, the second synchronizer S2 engages, the first motor 2 drives the first output shaft 6 by the second synchronizer S2 and the corresponding gears, and the second motor 3 drives the second output shaft 8 by the eighth gear C2 and the ninth gear C3.

The switching process is as follows: firstly, the load of the first motor 2 is unloaded to the second motor 3, and the second motor 3 continues to drive; then, the second synchronizer S2 disengages the gear; next, after the motor performs synchronization adjustment, the first synchronizer S1 engages the left gear; the first motor 2 drives and starts the engine 1 by the gear pair A3/A1, the first synchronizer S1, and the input shaft 4; and then, the engine 1 enters a working state, outputs power, drives the first motor 2 to generate electric power, supplies the power for the second motor 3 to drive the vehicle, and the system enters the series drive HEV mode.

The engine of this system has four gear positions. The series drive mode is only used when the vehicle speed is very low (more than ten kilometers per hour). When the vehicle speed is a little high, the system will engage the gear and enter the parallel drive mode. Accordingly, the drive time of the second motor 3 is very short.

The series HEV mode is switched to the four-wheel drive parallel HEV mode.

When the vehicle speed is very low (within more than ten kilometers per hour), the system is in the series drive HEV mode. As the vehicle speed increases, the system enters the four-wheel drive parallel HEV mode. The engine 1 has four gear positions, that is, the engine 1 can directly drive the vehicle at four different speed ratios. The working efficiency of the engine 1 is higher than that of a series-parallel hybrid power transmission system with three gears or less. The first motor 2 has two gear positions A2/A3′ and B2/B3, which can achieve a good balance between the acceleration performance and the fuel economy. Meanwhile, the torque and speed requirements are reduced, which is beneficial for reducing costs, weight, and NVH. The second motor 3 has a medium speed ratio, and the torque and speed requirements of the second motor 3 are moderate.

The series HEV mode can be smoothly switched to a first gear in the four-wheel drive parallel HEV mode. In the series HEV mode, when the first synchronizer S1 engages the left gear, the first output shaft 6 is connected to the input shaft 4, and the engine 1 drives the first motor 2 to generate power; and the second motor 3 of a rear axle drives the second output shaft 8 by the eighth gear C2 and the ninth gear C3. The series drive mode is switched to the parallel drive mode by the following steps: the second motor 3 of the rear axle continues to drive, so that the vehicle has no power interruption; the first motor 2 of a front axle drives the engine 1 to adjust the speed, so that when the third gear A3 is synchronized with the first output shaft 6, the second synchronizer S2 engages the left gear; then the torque is adjusted and distributed to enter a first-gear parallel drive mode; and the engine 1 drives the first output shaft 6 by the input shaft 4, the first gear A1, and the third gear A3. The second motor 3 of the rear axle drives the second output shaft 8 by the second motor shaft 7, the eighth gear C2, and the ninth gear C3.

Similarly, the system can switch from the series drive HEV mode to other gear positions in the four-wheel drive parallel HEV mode.

Gear shifting without power interruption is performed in the HEV mode.

The system can implement gear shifting without power interruption. During gear shifting, the engine 1 is unloaded (the output torque is reduced to zero); the second motor 3 compensates for unloading of the engine 1 and maintains drive by the eighth gear C2 and the ninth gear C3; after the original gear position synchronizer disengages the gear, the first motor 2 drives the engine 1 to perform synchronization adjustment; and when the new gear is synchronized with the relevant shaft, the synchronizer engages the gear; and then the torque is adjusted and distributed to complete gear shifting.

A first gear of an HEV can be smoothly switched to a second gear of the HEV: when the engine 1 is unloaded, the second motor 3 increases the torque for compensation; the second motor 3 continues to drive by the eighth gear C2 and the ninth gear C3, so that there is no power interruption in the vehicle; after the torque of the engine 1 is reduced to zero, the left gear of the first synchronizer S1 can be easily disengaged; then, the first motor 2 drives the engine 1 to adjust the speed, so that the second gear B1 is synchronized with the input shaft 4; and then the first synchronizer S1 engages the right gear, the engine 1 drives the first output shaft 6 by the input shaft 4, the second gear B1, the fourth gear B3, the sixth gear B2, the fifth gear A2, and the tenth gear A3′, and the engine 1 engages the second gear of the HEV After the engine 1 engages the second gear of the HEV, the second motor 3 can choose to work or not, and can be switched to the drive or power generation state at any time as needed.

The second gear of the HEV can be smoothly switched to a third gear of the HEV: when the engine 1 is unloaded, the second motor 3 increases the torque for compensation; the second motor 3 continues to drive by the eighth gear C2 and the ninth gear C3, so that there is no power interruption in the vehicle; after the torque of the engine 1 is reduced to zero, the left gear position of the second synchronizer S2 can be easily disengaged; then, the first motor 2 drives the engine 1 to adjust the speed, so that the fourth gear B3 is synchronized with the first output shaft 6, and then the second synchronizer S2 engages the right gear; and the engine 1 drives the second output shaft 8 by the input shaft 4, the second gear B1, and the fourth gear B3, and the engine 1 engages the third gear of the HEV. After the engine 1 engages the third gear of the HEV, the second motor 3 can choose to work or not, and can be switched to the drive or power generation state at any time as needed.

The third gear of the HEV can be smoothly switched to a fourth gear of the HEV: when the engine 1 is unloaded, and the second motor 3 increases the torque for compensation; the second motor 3 continues to drive by the eighth gear C2 and the ninth gear C3, so that there is no power interruption in the vehicle; after the torque of the engine 1 is reduced to zero, the right gear of the first synchronizer S1 can be easily disengaged; then, the first motor 2 drives the engine 1 to adjust the speed, so that the first gear A1 is synchronized with the first output shaft 6, and then the first synchronizer S1 engages the left gear; and the engine 1 drives the first output shaft 6 by the input shaft 4, the first gear A1, the third gear A3, the tenth gear A3′, the fifth gear A2, the sixth gear B2, and the fourth gear B3, and the engine 1 engages the fourth gear of the HEV. After the engine engages the fourth gear of the HEV, the second motor 3 can choose to work or not, and can be switched to the drive or power generation state at any time as needed.

### Embodiment 3

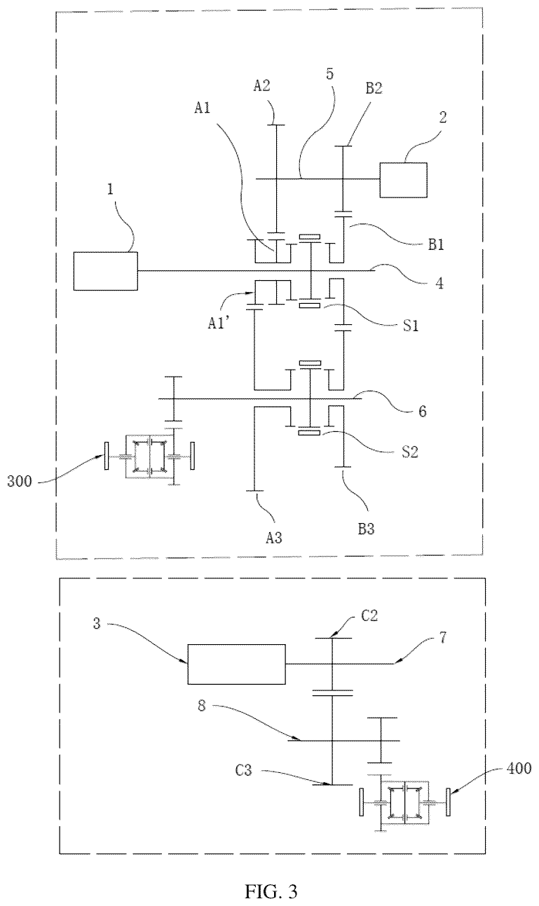

As shown in FIG. 3, a hybrid power system in the present disclosure includes a front wheel drive system and a rear wheel drive system.

The front wheel drive system includes an engine 1, a first motor 2, a parallel shaft gear set, and two pairs of synchronizers required for gear shifting. The engine 1 has four gear positions, and the first motor 2 has two gear positions. The two pairs of synchronizers implement gear position switching, thereby achieving a single type of gear shifting mechanism, a simple actuation mechanism, and low costs. A speed change mechanism composed of the parallel shaft gears and the synchronizers has mature technology, low manufacturing costs, high transmission efficiency, and low energy loss.

The engine 1 is connected to the input shaft 4. The input shaft 4 is provided with a first synchronizer S1, a first gear A1, an eleventh gear A1′, and a second gear B1, where the first gear A1 and the eleventh gear A1′ are fixedly connected; if the first synchronizer S1 engages a left gear, then the input shaft 4 is connected to the first gear A1 and the eleventh gear A1′; and if the first synchronizer S1 engages a right gear, then the input shaft 4 is connected to the second gear B1.

A first output shaft 6 is provided with a third gear A3, a fourth gear B3, and a second synchronizer S2. When the second synchronizer S2 engages the left gear, the first output shaft 6 is connected to the third gear A3. When the second synchronizer S2 engages the right gear, the first output shaft 6 is connected to the fourth gear B3. The third gear A3 is meshed with the eleventh gear A1′. The fourth gear B3 is meshed with the second gear B1.

The first motor 2 is connected to the first motor shaft 5. The first motor shaft 5 is provided with a fifth gear A2 and a sixth gear B2. The fifth gear A2 is meshed with the first gear A1. The sixth gear B2 is meshed with the second gear B1.

In a second drive system 200, a second motor 3 outputs power by an eighth gear C2 on a second motor shaft 7, a ninth gear C3 on a second output shaft 8, and a final drive. A speed reduction mechanism C3/C2 has a medium speed ratio.

System function table 3

| | | First | Second | | |
|---|---|---|---|---|---|
| | Engine 1 | motor 2 | motor 3 | S1 | S2 |
| EV medium | Off | Drive | Drive | | Right |
| and low-speed | | | | | |
| drive | | | | | |
| EV on-load | Off | Synchron- | Drive | | Right |
| gear shifting | | ization | | | <=> |
| | | adjustment | | | left |
| EV medium | Off | Drive | Drive | | Left |
| and high- | | | | | |
| speed drive | | | | | |
| EV => series | Off => | Drive of | Drive | Left | |
| HEV | start | engine 1 | | (or | |
| | | | | right) | |
| Series HEV | Drive | Power | Drive | Left | |
| | | generation | | (or | |
| | | | | right) | |
| Series <=> | Following | Synchron- | Drive | Left | off <=> |
| first gear | | ization | | | left |
| | | adjustment | | | |
| HEV medium | Drive | Drive | Drive | Left | Right/ |
| and low-speed | | | | | left |
| drive | | | | | |
| HEV on-load | Following | Synchron- | Drive | Left | Left |
| gear shifting | | ization | | <=> | <=> |
| | | adjustment | | right | right |
| HEV medium | Drive | Drive | Drive | Right | Right/ |
| and high- | | | | | left |
| speed drive | | | | | |
| Energy | Idling or | Braking/ | Supple- | Left/ | Left/ |
| regenerative | stalling | power | mentation | right | right |
| braking | | generation | | | |
| Vehicle | Off | Gear | Off | | |
| towing | | disengage- | | | |
| | | ment/off | | | |

Note:
D/G represents that the motor is connected to a transmission chain and follows, and can be switched to a drive or power generation state at any time as needed.

When the system works in various modes, the components are set as follows.

In a two-wheel drive EV mode, when the engine 1 is off, the first synchronizer S1 and the second synchronizer S2 disengage the gears, and the second motor 3 outputs power by the eighth gear C2 on the second motor shaft 7, the ninth gear C3 on the second output shaft 8, and the final drive. The speed reduction mechanism (C3/C2) has a medium speed ratio. A medium speed ratio of the second motor 3 is between two speed ratios of the first motor 2.

In a four-wheel drive EV mode, when the engine 1 is off, the first synchronizer S1 disengages the gear to cut off the connection with the transmission chain; the second synchronizer S2 engages the fourth gear B3 (or the third gear A3), the first motor 2 drives the first output shaft 6 and front wheels 300 by the gear pair B2/B3 (or the gear pair A2′/A3), and the second drive system 200 drives rear wheels 400, thereby implementing four-wheel drive of an EV; and the first motor 2 has two gear positions: a high speed ratio B3/B2 and a low speed ratio A2/A1/A1′/A3 as in this embodiment.

In a series HEV mode, when the engine 1 is on, the first synchronizer S1 engages one gear position, the engine 1 is connected to the first motor 2; the second synchronizer S2 is separated, and the engine 1 is separated from the first output shaft 6; and the engine 1 drives the first motor 2 to generate power and supplies the power to the second drive system 200, and the second drive system 200 drives a corresponding pair of (rear) wheels.

In a four-wheel drive parallel HEV mode, when the engine 1 is on, the first synchronizer S1 engages one gear position and the second synchronizer S2 engages one gear position, the engine 1 and the first motor 2 drive the front wheels 300 by transmission gears and the first output shaft 6, and the second drive system 200 drives the rear wheels 400. The two synchronizers have four combinations of gear engagement states to constitute four gear positions of the engine 1. Specifically, when the first synchronizer S1 moves left and the second synchronizer S2 moves left, the engine 1 drives the first output shaft 6 by the gear set A1′ and A3, which is a first gear position; when the first synchronizer S1 moves left and the second synchronizer S2 moves right, the engine 1 drives the first output shaft 6 by the gear set A1, A2, B2, B1, and B3, which is a second gear position; when the first synchronizer S1 moves right and the second synchronizer S2 moves left, the engine 1 drives the first output shaft 6 by the gear set B1, B2, A2, A1, A1′, and A3, which is a third gear position; and when the first synchronizer S1 moves right and the second synchronizer S2 moves right, the engine 1 drives the first output shaft 6 by the gear set B1 and B3, which is a fourth gear position.

EV modes are as follows.

In a rear-wheel drive EV mode, when the engine 1 is off, the first synchronizer S1 and the second synchronizer S2 disengage the gears, and the second motor 3 drives the wheels by the eighth gear C2 on the second motor shaft 7, the ninth gear C3 on the second output shaft 8, and a differential or the speed reduction mechanism. The eighth gear C2 and the ninth gear C3 cooperate to form a medium speed ratio.

In the four-wheel drive EV mode, when the engine 1 is off, the first synchronizer S1 disengages the gear to cut off the connection between the engine 1 and the first output shaft 6; and the second synchronizer S2 engages one of the gear positions, the first motor 2 drives the first output shaft 6 by the gear related to gear engagement, and the second motor 3 drives the second output shaft 8 by the eighth gear C2 and the ninth gear C3, thereby implementing four-wheel drive.

Gear shifting without power interruption is performed in the four-wheel drive EV mode.

In the four-wheel drive EV mode, the first motor 2 shifts from the gear position with the high speed ratio EV I to the gear position with the low speed ratio EV III, where the first motor 2 transfers a load to the second motor 3, and the second motor 3 continues to drive; after the first motor 2 is unloaded, the second synchronizer S2 disengages the right gear; the first motor 2 performs synchronization adjustment, and after the third gear A3 is synchronized with the first output shaft 6, the second synchronizer S2 engages a left gear; and torque distribution is adjusted to complete gear shifting.

The first motor 2 shifts from the gear position with the low speed ratio EV III to the gear position with the high speed ratio EV I, where the first motor 2 transfers the load to the second motor 3, and the second motor 3 continues to drive; after the first motor 2 is unloaded, the second synchronizer S2 disengages the left gear; the first motor 2 performs synchronization adjustment, and after the fourth gear B3 is synchronized with the first output shaft 6, the second synchronizer S2 engages the right gear; and torque distribution is adjusted to complete gear shifting.

From this, it can be seen that in the EV mode, when the first motor 2 performs gear shifting, there is always the second motor 3 driving and compensating for a torque of the first motor 2, so there is no power interruption during gear shifting.

The four-wheel drive EV mode is switched to the series HEV mode.

The vehicle can smoothly switch from the four-wheel drive EV mode to the series drive HEV mode.

Before switching, in the four-wheel drive EV mode, when the engine 1 is off, the first synchronizer S1 disengages the gear, the second synchronizer S2 engages, the first motor 2 drives the first output shaft 6 by the second synchronizer S2 and the corresponding gears, and the second motor 3 drives the second output shaft 8 by the eighth gear C2 and the ninth gear C3.

The switching process is as follows: first, the load of the first motor 2 is transferred to the second motor 3, and the second motor continues to drive; then, the second synchronizer S2 disengages the gear; next, after the motor performs synchronization adjustment, the first synchronizer S1 engages the right gear; the first motor 2 drives and starts the engine 1 by the gear pair B2/B1, the first synchronizer S1, and the input shaft 4; and then, the engine 1 enters a working state, outputs power, drives the first motor 2 to generate power, supplies the power to the second motor 3, and drives the vehicle, and the system enters the series drive HEV mode.

The engine of this system has four gear positions. The series drive mode is only used when the vehicle speed is very low (more than ten kilometers per hour). When the vehicle speed is a little high, the system will engage the gear and enter the parallel drive mode. Accordingly, the drive time of the second motor 3 is very short.

The series HEV mode is switched to the four-wheel drive parallel HEV mode.

When the vehicle speed is very low (within more than ten kilometers per hour), the system is in the series drive HEV mode. As the vehicle speed increases, the system enters the four-wheel drive parallel HEV mode. The engine 1 has four gear positions, that is, the engine 1 can be directly driven at four different speed ratios. The working efficiency of the engine 1 is higher than that of a series-parallel hybrid power transmission system with three gears or less. The first motor 2 has two gear positions, which can achieve a good balance between the acceleration performance and the fuel economy. Meanwhile, the torque and speed requirements are reduced, which is beneficial for reducing costs, weight, and NVH. The second motor 3 has a medium speed ratio, and the torque and speed requirements of the second motor 3 are moderate.

The series HEV mode can be smoothly switched to a first gear of an HEV. In the series HEV mode, when the first synchronizer S1 engages the left gear, the first motor shaft 5 is connected to the input shaft 4, and the engine 1 drives the first motor 2 to generate power; and the second motor 3 of a rear axle drives the second output shaft 8 by the eighth gear C2 and the ninth gear C3. The series drive mode is switched to the parallel drive mode by the following steps: the second motor 3 of the rear axle continues to drive, so that the vehicle has no power interruption; the first motor 2 of a front axle drives the engine 1 to adjust the speed, so that when the third gear A3 is synchronized with the second output shaft 8, the second synchronizer S2 engages the left gear; then the torque is adjusted and distributed to enter a first-gear parallel drive mode (i.e., the first gear of the HEV); and the engine 1 drives the first output shaft 6 by the first output shaft 6, the first gear A1, and the third gear A3. The second motor 3 of the rear axle drives the second output shaft 8 by the second motor shaft 7, the eighth gear C2, and the ninth gear C3.

Similarly, the system can switch from the series drive HEV mode to other gear positions in the four-wheel drive parallel HEV mode.

Gear shifting without power interruption is performed in the HEV mode.

The system can implement gear shifting without power interruption. During gear shifting, the engine 1 is unloaded (the output torque is reduced to zero); the second motor 3 compensates for unloading of the engine 1 and maintains drive by the eighth gear C2 and the ninth gear C3; after the original gear position synchronizer disengages the gear, the first motor 2 drives the engine 1 to perform synchronization adjustment; and when the new gear is synchronized with the relevant shaft, the synchronizer engages the gear; and then the torque is adjusted and distributed to complete gear shifting.

The first gear of the HEV can be smoothly switched to a second gear of the HEV: when the engine 1 is unloaded, the second motor 3 increases the torque for compensation; the second motor 3 continues to drive by the eighth gear C2 and the ninth gear C3, so that there is no power interruption in the vehicle; after the torque of the engine 1 is reduced to zero, the left gear of the second synchronizer S2 can be easily disengaged; then, the first motor 2 drives the engine 1 to adjust the speed, so that the fourth gear B3 is synchronized with the first output shaft 6; and then the second synchronizer S2 engages the right gear, the engine 1 drives the first output shaft 6 by the input shaft 4, the first gear A1, the fifth gear A2, the sixth gear B2, the second gear B1, and the fourth gear B3, and the engine 1 engages the second gear of the HEV After the engine 1 engages the second gear of the HEV, the second motor 3 can choose to work or not, and can be switched to the drive or power generation state at any time as needed.

The second gear of the HEV can be smoothly switched to a third gear of the HEV: when the engine 1 is unloaded, the second motor 3 increases the torque for compensation; the second motor 3 continues to drive by the eighth gear C2 and the ninth gear C3, so that there is no power interruption in the vehicle; after the torque of the engine 1 is reduced to zero, the left gear position of the first synchronizer S1 can be easily disengaged; then, the first motor 2 drives the engine 1 to adjust the speed, so that the second gear B1 is synchronized with the input shaft 4, and then the first synchronizer S1 engages the right gear; and the engine 1 drives the first output shaft 6 by the input shaft 4, the second gear B1, and the fourth gear B3, and the engine 1 engages the third gear of the HEV. After the engine 1 engages the third gear of the HEV, the second motor 3 can choose to work or not, and can be switched to the drive or power generation state at any time as needed.

The third gear of the HEV can be smoothly switched to a fourth gear of the HEV: when the engine 1 is unloaded, the second motor 3 increases the torque for compensation; the second motor 3 continues to drive by the eighth gear C2 and the ninth gear C3, so that there is no power interruption in the vehicle; after the torque of the engine 1 is reduced to zero, the right gear of the second synchronizer S2 can be easily disengaged; then, the first motor 2 drives the engine 1 to adjust the speed, so that the third gear A3 is synchronized with the first output shaft 6, and then the second synchronizer S2 engages the left gear; and the engine 1 drives the first output shaft 6 by the input shaft 4, the second gear B1, the sixth gear B2, the fifth gear A2, the first gear A1, and the third gear A3, and the engine 1 engages the fourth gear of the HEV After the engine 1 engages the fourth gear of the HEV, the second motor 3 can choose to work or not, and can be switched to the drive or power generation state at any time as needed.

The above descriptions are merely embodiments using the technical content of the present disclosure. Any modifications or variations made by those skilled in the art using the present disclosure fall within the scope of patent claimed in the present disclosure and are not limited to those disclosed in the embodiments.

1. A four-wheel drive multi-gear hybrid power transmission system, comprising a first drive system and a second drive system, wherein
the first drive system comprises an engine, a first motor, an input shaft, a first motor shaft, a first output shaft, a first synchronizer, a second synchronizer, and a plurality of gear sets,
the input shaft is connected to the engine,
the first motor shaft is connected to the first motor,
the first synchronizer is connected to the input shaft,
the second synchronizer is connected to the first output shaft,
the input shaft, the first motor shaft, and the first output shaft are provided with the matched gear sets to implement transmission connection,
the input shaft implements gear shifting with at least two gears on the input shaft by the first synchronizer,
the first output shaft implements gear shifting with at least two gears on the first output shaft by the second synchronizer,
at least two gears are arranged on the first motor shaft,
the first drive system outputs a first torque by the first output shaft to provide front wheel drive power or rear wheel drive power,
the second drive system comprises a second motor, a second motor shaft, and a second output shaft,
the second motor and the second output shaft are connected directly or by a speed reduction transmission mechanism, and
the second drive system outputs a second torque by the second output shaft to provide the rear wheel drive power or the front wheel drive power.

2. The four-wheel drive multi-gear hybrid power transmission system according to claim 1, wherein
the input shaft is sleeved with left gears and right gears and is connected or not connected to the left gears and the right gears on the input shaft separately by the first synchronizer,
the first output shaft is sleeved with left gears and right gears and is connected or not connected to the left gears and the right gears on the first output shaft separately by the second synchronizer, and
the first motor shaft is provided with left gears and right gears that are in meshing transmission with corresponding gears on at least one of the input shaft or the first output shaft.

3. The four-wheel drive multi-gear hybrid power transmission system according to claim 2, wherein
the first motor shaft is disposed between the input shaft and the first output shaft,
a parallel shaft system with an arrangement of the input shaft, the first motor shaft, and the first output shaft is formed from one side of a power input of the four-wheel drive multi-gear hybrid power transmission system to a second side of a power output of the four-wheel drive multi-gear hybrid power transmission system,
the left gears and the right gears on the first motor shaft are two gears connected side by side and are meshed with the left gears and the right gears on the input shaft and the first output shaft respectively, and
the right gears on the first motor shaft are meshed with the right gears on the input shaft and the first output shaft respectively.

4. The four-wheel drive multi-gear hybrid power transmission system according to claim 3, comprising a plurality of drive modes, wherein
the plurality of drive modes comprise a two-wheel drive electric vehicle (EV) mode, a four-wheel drive EV mode, a series hybrid electric vehicle (HEV) mode, and a four-wheel drive parallel HEV mode,
in the two-wheel drive EV mode, when the engine is off, the first synchronizer is disengaged; and when the second synchronizer is disengaged, the second motor drives the second output shaft by a gear set consisting of a gear of the at least two gears on the second motor shaft and a gear of the at least two gears on the second output shaft meshing with each other to output power;
in the four-wheel drive EV mode, when the engine is off, the first synchronizer is disengaged; and when the second synchronizer engages one of gear positions, the first motor drives the first output shaft by a gear set consisting of a gear of the at least two gears on the first motor shaft and a gear of the at least two gears on the first output shaft meshing with each other to output power to drive a first pair of wheels, and the second drive system drives a second pair of wheels;
in the series HEV mode, when the first synchronizer engages one gear position, the engine is connected to the first motor; and when the second synchronizer is disengaged, the engine is separated from the first output shaft, the engine drives the first motor to generate power and supplies the power to the second drive system, and the second drive system drives the second pair of wheels; and
in the four-wheel drive parallel HEV mode, when the first synchronizer engages one gear position and the second synchronizer engages one gear position, the engine and the first motor drive the first pair of wheels by a first gear set consisting of a gear of the at least two gears on the first motor shaft and a gear of the at least two gears on the first output shaft meshing with each other together with a second gear set consisting of a second gear of the at least two gears on the first motor shaft and a gear of the at least two gears on the input shaft meshing with each other, or a third gear set consisting of a gear of the at least two gears on the input shaft and a gear of the at least two gears on the first output shaft meshing with each other together with a fourth gear set consisting of a gear of the at least two gears on the first motor shaft and a second gear of the at least two gears on the first output shaft meshing with each other, or a fifth gear set consisting of a gear of the at least two gears on the input shaft and a gear of the at least two gears on the first output shaft meshing with each other together with a second gear set consisting of a gear of the at least two gears on the first motor shaft and a second gear of the at least two gears on the input shaft meshing with each other and the first output shaft, the second drive system drives the second pair of wheels, and the first synchronizer and the second synchronizer each has two gear engagements and together form four combinations to constitute four gear positions of the engine.

5. The four-wheel drive multi-gear hybrid power transmission system according to claim 2, wherein
the first motor shaft is disposed behind the first output shaft,
a parallel shaft system with an arrangement of the input shaft, the first output shaft, and the first motor shaft is formed from one side of a power input of the four-wheel drive multi-gear hybrid power transmission system to a second side of a power output of the four-wheel drive multi-gear hybrid power transmission system,
the left gears and the right gears on the first output shaft are two gears connected side by side and are meshed with the left gears and the right gears on the input shaft and the first motor shaft respectively,
the right gears on the first output shaft are meshed with the right gears on the input shaft and the first motor shaft respectively.

6. The four-wheel drive multi-gear hybrid power transmission system according to claim 5, comprising a plurality of drive modes, wherein
the plurality of drive modes comprise a two-wheel drive electric vehicle (EV) mode, a four-wheel drive EV mode, a series hybrid electric vehicle (HEV) mode, and a four-wheel drive parallel HEV mode,
wherein in the two-wheel drive EV mode, when the engine is off, the first synchronizer is disengaged; and when the second synchronizer is disengaged, the second motor drives the second output shaft by a gear set consisting of a gear of the at least two gears on the second motor shaft and a gear of the at least two gears on the second output shaft meshing with each other to output power;
in the four-wheel drive EV mode, when the engine is off, the first synchronizer is disengaged; and when the second synchronizer engages one of gear positions, the first motor drives the first output shaft by a first gear set consisting of a gear of the at least two gears on the first motor shaft and a gear of the at least two gears on the first output shaft meshing with each other together with a second gear set consisting of a second gear of the at least two gears on the first motor shaft and a gear of the at least two gears on the input shaft meshing with each other, or a third gear set consisting of a gear of the at least two gears on the input shaft and a gear of the at least two gears on the first output shaft meshing with each other together with a fourth gear set consisting of a gear of the at least two gears on the first motor shaft and a second gear of the at least two gears on the first output shaft meshing with each other, or a fifth gear set consisting of a gear of the at least two gears on the input shaft and a gear of the at least two gears on the first output shaft meshing with each other together with a second gear set consisting of a gear of the at least two gears on the first motor shaft and a second gear of the at least two gears on the input shaft meshing with each other to output power to drive a first pair of wheels, and the second drive system drives a second pair of wheels;
in the series HEV mode, when the first synchronizer engages one gear position, the engine is connected to the first motor; and when the second synchronizer disengages the gear, the engine is separated from the first output shaft, the engine drives the first motor to generate power and supplies the power to the second drive system, and the second drive system drives the second pair of wheels; and
in the four-wheel drive parallel HEV mode, when the first synchronizer engages one gear position and the second synchronizer engages one gear position, the engine and the first motor drive the first pair of wheels by a first gear set consisting of a gear of the at least two gears on the first motor shaft and a gear of the at least two gears on the first output shaft meshing with each other together with a second gear set consisting of a second gear of the at least two gears on the first motor shaft and a gear of the at least two gears on the input shaft meshing with each other, or a third gear set consisting of a gear of the at least two gears on the input shaft and a gear of the at least two gears on the first output shaft meshing with each other together with a fourth gear set consisting of a gear of the at least two gears on the first motor shaft and a second gear of the at least two gears on the first output shaft meshing with each other, or a fifth gear set consisting of a gear of the at least two gears on the input shaft and a gear of the at least two gears on the first output shaft meshing with each other together with a second gear set consisting of a gear of the at least two gears on the first motor shaft and a second gear of the at least two gears on the input shaft meshing with each other and the first output shaft, the second drive system drives the second pair of wheels, and the first synchronizer and the second synchronizer each has two gear engagements and together form four combinations to constitute four gear positions of the engine.

7. The four-wheel drive multi-gear hybrid power transmission system according to claim 2, wherein
the first motor shaft is disposed in front of the input shaft,
a parallel shaft system with an arrangement of the first motor shaft, the input shaft, and the first output shaft is formed from one side of a power input of the four-wheel drive multi-gear hybrid power transmission system to a second side of a power output of the four-wheel drive multi-gear hybrid power transmission system,
the left gears and the right gears on the input shaft are two gears connected side by side and are meshed with the left gears and the right gears on the first motor shaft and the first output shaft respectively, and
the right gears on the input shaft are meshed with the corresponding gears on the first motor shaft and the first output shaft respectively.

8. The four-wheel drive multi-gear hybrid power transmission system according to claim 7, comprising a plurality of drive modes, wherein:
the plurality of drive modes comprise a two-wheel drive electric vehicle (EV) mode, a four-wheel drive EV mode, a series hybrid electric vehicle (HEV) mode, and a four-wheel drive parallel HEV mode,
in the two-wheel drive EV mode, when the engine is off, the first synchronizer is disengaged; and when the second synchronizer is disengaged, the second motor drives the second output shaft by a gear set consisting of a gear of the at least two gears on the second motor shaft and a gear of the at least two gears on the second output shaft meshing with each other to output power;
in the four-wheel drive EV mode, when the engine is off, the first synchronizer is disengaged; and when the second synchronizer engages one of gear positions, the first motor drives the first output shaft by a first gear set consisting of a gear of the at least two gears on the first motor shaft and a gear of the at least two gears on the first output shaft meshing with each other together with a second gear set consisting of a second gear of the at least two gears on the first motor shaft and a gear of the at least two gears on the input shaft meshing with each other, or a third gear set consisting of a gear of the at least two gears on the input shaft and a gear of the at least two gears on the first output shaft meshing with each other together with a fourth gear set consisting of a gear of the at least two gears on the first motor shaft and a second gear of the at least two gears on the first output shaft meshing with each other, or a fifth gear set consisting of a gear of the at least two gears on the input shaft and a gear of the at least two gears on the first output shaft meshing with each other together with a second sixth gear set consisting of a gear of the at least two gears on the first motor shaft and a second gear of the at least two gears on the input shaft meshing with each other to output power to drive a first pair of wheels, and the second drive system drives a second pair of wheels;
in the series HEV mode, when the first synchronizer engages one gear position, the engine is connected to the first motor; and when the second synchronizer is disengaged, the engine is separated from the first output shaft, the engine drives the first motor to generate power and supplies the power to the second drive system, and the second drive system drives the second pair of wheels; and
in the four-wheel drive parallel HEV mode, when the first synchronizer engages one gear position and the second synchronizer engages one gear position, the engine and the first motor drive the first pair of wheels by a gear set consisting of a gear of the at least two gears on the first motor shaft and a gear of the at least two gears on the first output shaft meshing with each other and the first output shaft, the second drive system drives the second pair of wheels, and the first synchronizer and the second synchronizer each has two gear engagements and together form four combinations to constitute four gear positions of the engine.

9. A hybrid vehicle, comprising the four-wheel drive multi-gear hybrid power transmission system according to claim 1.
